(19) United States
(12) Patent Application Publication
(10) Pub. No.: US 2011/0000627 A1
(43) Pub. Date: Jan. 6, 2011

(54) Dual-Function Shade for Glass Window/Door

(76) Inventor: Feng Sun, (US)

Correspondence Address: Feng Sun, 5263 Candy Root Ct, Columbia, MD, 21045, US

(21) Appl. No.: 12/497,737

(22) Filed: Jul. 6, 2009

(51) Int. Cl. E06B 9/24

(52) U.S. Cl. 160/127

(57) ABSTRACT

A dual-function shade includes a piece of transparency printed with an image and applied with adhesive material. The shade is directly attached to the glass to be treated by the adhesive material. The shade acts as a glowing display lit by daylight and provides privacy all the time. The printed image can be a single or a group of pictures. The depth of color can be chosen to have the desired brightness and displaying effect. Multiple shades can be used together to cover a piece of glass. The shade can be trimmed to fit into the glass with different shape or size. A portion of shade can be left clear to resemble a shade that covers a portion of a window/door. The shade with UV protection can be obtained by adding an UV absorbing agent to the transparency. An online server system can be setup to generate the customized shade.

### FIELD OF THE INVENTION

The present invention relates to a window/door shade system, and more particularly to a shade system, which acts as a glowing display lit by daylight by employing the glass window/door of the building.

### REFERENCES CITED

| | | |
|---|---|---|
| 5,1917,48 | March 1993 | Baughman |
| 7,525,604 | April 2009 | Xue |
| 7,517,583 | April 2009 | Onishi et al. |
| 7,314,079 | January 2008 | Yano et al. |

### BACKGROUND

Glass windows/doors that can transmit daylight without losing privacy would be beneficial in a variety of applications. Great efforts have been expended to improve the ways and means of the transmission of light through glass windows/doors. Common approaches to light control can be: blind sheet shade, light filtering shade, opaque window shade, laminated glass or even electrically controllable transmission and reflection. An illuminated window display has been proposed utilizing large glass surface of building with shade material adapted to be backlit from the building interior. While these shade and display systems differ substantially from each other with regard to structure, material composition and energy consumption, to the knowledge of the present inventor, none of them takes advantage of the natural daylight coming through the glass to generate a conveniently replaceable glowing display.

### SUMMARY

It is an object of the present invention to provide a dual-function shade that acts as a glowing display in the room lit by natural daylight, and eliminates the view from the outside to ensure the privacy all the time even when the inside is lit. Such a dual-function shade would provide users very substantial opportunities to create unique artistic indoor decoration. The following embodiments and aspects of thereof are described and they are meant to be exemplary and illustrative, and not limiting the scope.

The dual-function shade comprises at least one piece of transparency printed with an image. The printed image can be a single picture, or a group of selected pictures, borders can be even created between pictures, to acquire the artistic appeal. The depth of color of the picture can be chosen to allow desired amount of light transmitting through the dual-function shade. The printed transparency is directly attached to the glass of window/door to be treated by appropriate adhesive material. The peelable adhesive material can be used for adhering the transparency to the glass. Thus, existing dual-function shade can be conveniently replaced by another dual-function shade with different style to increase the novelty of the decoration.

A plurality of dual-function shades may be used side-by-side together to fully cover a large piece of glass of window/door to preserve the privacy. A portion of the transparency can be left clear to allow the corresponding part of the glass to remain transmissive, akin to a window blind that can be used to cover and block light through only a portion of a window. The dual-function shade can be trimmed to fit into the glass window/door with different size or shape. An ultraviolet (UV) absorbing agent can be added to the transparency to make the dual-function shade more preferable to the users.

An online server system can be set up to print out the images uploaded by the users to produce customized dual-function shade. The server system can provide online picture library and picture editing tool for the users to create their own dual-function shade. After the users have finalized their picture design, the server can print out the customized dual-function shade and send it back to the users.

### BRIEF DESCRIPTION OF THE DRAWINGS

Exemplary embodiments are illustrated in referenced figures of the drawings. It is intended that the embodiments and figures disclosed herein be considered illustrative rather than limiting.

FIG. 1 is a front side view of the first embodiment of the present invention and illustrating a glass window/door covered with the dual-function shade of the present invention.

FIG. 2 is a side cross-sectional view taken vertically through the covered area shown in FIG. 1 and showing in diagrammatic form the glass, transparency, printed picture on the transparency and adhesive material of the first embodiment of the present invention.

FIG. 3 is a front side view of an alternate embodiment of the present invention and showing a plurality of pictures can be printed on one dual-function shade.

FIG. 4 is a front side view of another alternate embodiment of the present invention and showing a plurality of dual-function shades can be used side-by-side to cover one piece of glass.

FIG. 5 is a front side view of another alternate embodiment of the present invention and showing a portion of transparency can be left clear to allow the corresponding part of the glass to remain transmissive.

FIG. 6 is a front side view of another alternate embodiment of the present invention and showing the dual-function shade of the present invention can be trimmed to fit into the glass with different geometry or size.

FIG. 7 is a side cross-sectional view taken vertically through the covered area with UV protection added to the dual-function shade and showing in diagrammatic form the glass, transparency, UV absorbing agent, printed picture on the transparency and adhesive material of the dual-function shade of the present invention.

### DETAILED DESCRIPTION

The present invention provides a dual-function shade for glass window/door that acts as a glowing display during the daytime and provides privacy all day long. The display type and the layout of dual-function shade can vary over a wide range. In this regard, the following description of the dual-function shade is presented for purposes of illustration and wide variety of dual-function shades can be prepared using the principles of the present invention.

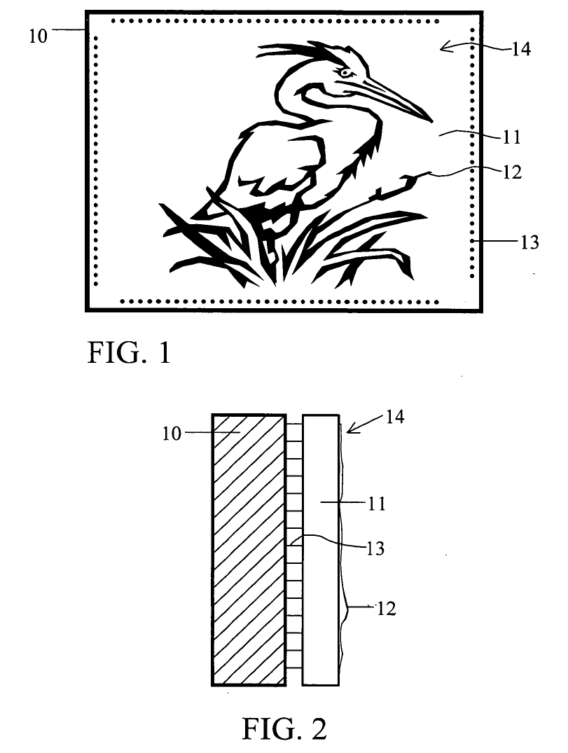

FIG. 1 shows the front side view of glass 10 covered with dual-function shade 14. FIG. 2 is the side cross-sectional view of glass 10 covered with dual-function shade 14 shown in FIG. 1. Dual-function shade 14 is constructed from a sheet of transparency 11, an image 12 printed on transparency 11, and adhesive material 13 used to attach the transparency 11 to the glass 10. The depth of color of the printed picture can be chosen to allow desired amount of light transmitting through the glass or to create the desired decorative effect. The peelable adhesive material can be used to allow easy replacement of the dual-function shade to increase the creativity of the decoration. The adhesive material 13 is generally commercially available.

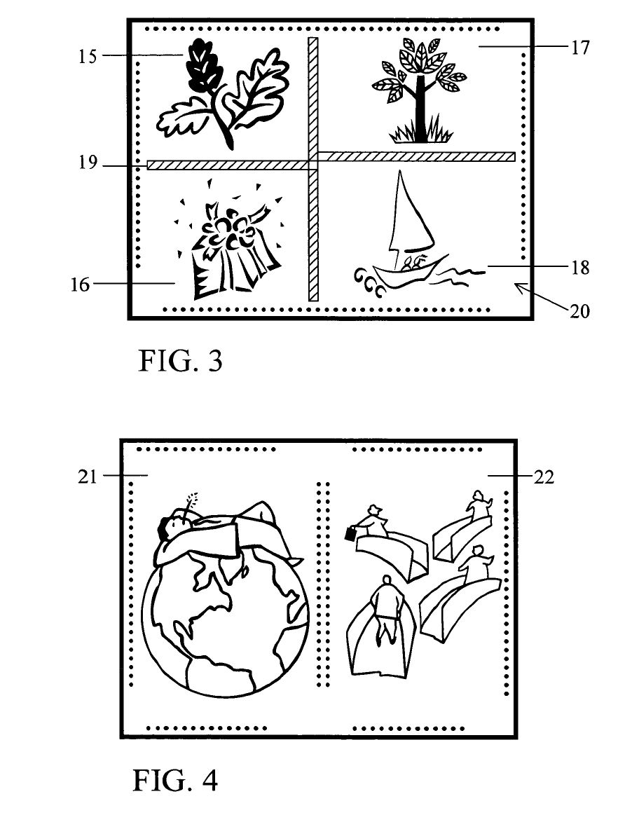

As shown in FIG. 3, four pictures, picture 15, picture 16, picture 17 and picture 18, can be printed on one dual-function shade 20 to expand the displaying capability. Border 19 can be created between the pictures to enhance the artistic appealing of the dual-function shade 20. Instead of the four pictures employed in FIG. 3, any number could be employed for artistic purposes.

As shown in FIG. 4, more than one dual-function shades, shade 21 and shade 22, can be used to cover one piece of glass. In this structure, the area of the treated glass is larger than the area of the individual dual-function shade. Thus, the broad applicability of the dual-function shade is demonstrated by using multiple dual-function shades side-by-side to cover a large piece of glass.

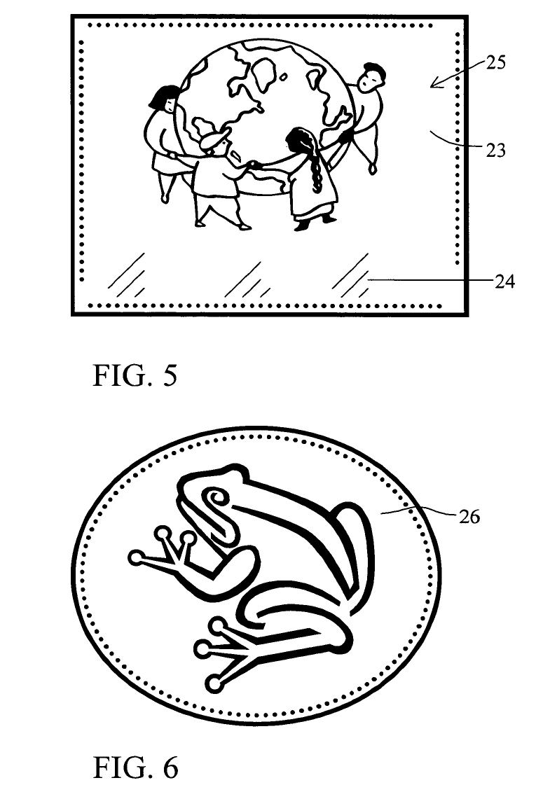

In FIG. 5, the dual-function shade 25 has a printed portion 23 and a clear portion 24. The clear portion 24 allows the corresponding area on the glass to remain transmissive. This structure resembles the shade that partially covers the glass window/door.

As shown in FIG. 6, the dual-function shade 26 can be used for the glass with irregular shape. By trimming the dual-function shade according to the shape or size of the glass, the dual-function shade can be adaptable to cover the glass with different geometry or size.

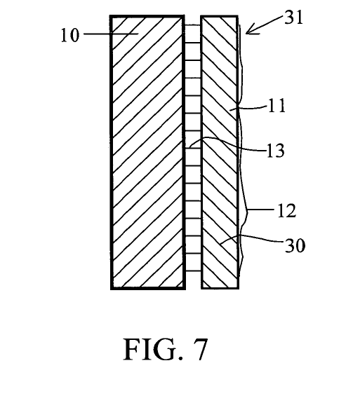

FIG. 7 shows the side cross-sectional view of glass 10 covered with dual-function shade 31 with an UV absorbing agent 30 added to the transparency 11 which is printed with image 12 and applied with adhesive material 13. The dual-function shade with UV protection may be preferable to the users since the daylight becomes mild to human without UV rays.

A still further feature of the present invention is the incorporation of Internet into the preparation of customized dual-function shade. The user can upload the image for the dual-function shade to the server system and let the server system print out and mail back the customized dual-function shade to the user. The server system can also provide online picture library and online picture editing tool for the users to design various customized dual-function shades.

What is claimed is:

1. A dual-function shade for glass window/door, comprising:
at least one piece of transparency;
at least one picture printed on said transparency;
an adherence means for attaching said transparency to said glass window/door.

2. The dual-function shade of claim 1, wherein said adherence means attaches said transparency printed with said picture to said glass window/door, and wherein said picture printed on said transparency glows inside lit by the daylight from the outside.

3. The dual-function shade of claim 1, wherein said adherence means attaches said transparency printed with said picture to said glass window/door, and wherein said picture printed on said transparency blocks the view from the outside through said glass window/door, providing privacy all the time.
